(19) United States
(12) Patent Application Publication
(10) Pub. No.: US 2024/0121415 A1
(43) Pub. Date: Apr. 11, 2024

(54) METHOD AND APPARATUS ENCODING/DECODING AN IMAGE

(71) Applicant: ELECTRONICS AND TELECOMMUNICATIONS RESEARCH INSTITUTE, Daejeon (KR)

(72) Inventors: Hyon Gon CHOO, Daejeon (KR); Han Shin LIM, Daejeon (KR); Sang Woon KWAK, Daejeon (KR)

(73) Assignee: ELECTRONICS AND TELECOMMUNICATIONS RESEARCH INSTITUTE, Daejeon (KR)

(21) Appl. No.: 18/377,404

(22) Filed: Oct. 6, 2023

(30) Foreign Application Priority Data
Oct. 7, 2022 (KR) 10-2022-0128910
Oct. 4, 2023 (KR) 10-2023-0131429

(51) Int. Cl. H04N 19/30; H04N 19/17

(52) U.S. Cl. CPC H04N 19/30; H04N 19/17

(57) ABSTRACT

An image encoding method includes detecting at least one attention region from an original image, acquiring a reconstructed picture for the original image, generating residual data between a first attention region in the original image and a second attention region corresponding to the first attention region in the reconstructed picture, and encoding the residual data.

### BACKGROUND OF THE INVENTION

### Field of the Invention

The present disclosure relates to an image encoding/decoding method and apparatus.

A main purpose of existing image processing techniques is to maintain best quality or improve quality for human viewing. However, in various industrial fields in the future, a main purpose of acquiring visible/invisible light image data is a machine learning task such as image recognition or image segmentation and a higher-level machine learning task based thereon in many cases. In the future, it may be more useful to set a goal of image encoding/decoding to maintain or improve performance as much as possible when applied to a machine learning-based task.

### SUMMARY OF THE INVENTION

The present disclosure provides a method and apparatus for additionally encoding/decoding residual data for an attention region in an image.

Specifically, the present disclosure provides a method and apparatus for encoding/decoding residual data between an attention region of an original image and an attention region of a reconstructed picture.

Specifically, the present disclosure provides a method and apparatus for encoding an image having a smaller resolution than that of an original image while minimizing restoration errors for an attention region in the encoded image.

The technical problems to be solved in the present disclosure are not limited to the technical problems mentioned above, and other technical problems not mentioned herein will be clearly understood by those skilled in the art to which the present disclosure belongs from the description below.

In accordance with an aspect of the present invention, the above and other objects can be accomplished by the provision of an image encoding method detecting at least one attention region from an original image, acquiring a reconstructed picture for the original image, generating residual data between a first attention region in the original image and a second attention region corresponding to the first attention region in the reconstructed picture, and encoding the residual data.

In accordance with another aspect of the present invention, there is provided an image encoding apparatus including an attention region detector configured to detect at least one attention region from an original image, a reconstructed picture acquisition unit configured to acquire a reconstructed picture for the original image, a residual data acquisition unit configured to generate residual data between a first attention region in the original image and a second attention region corresponding to the first attention region in the reconstructed picture, and a bitstream generator configured to generate a bitstream including the residual data.

In the image encoding method and the image encoding apparatus according to the present disclosure, the acquiring may include converting the original image having a first resolution to have a second resolution, encoding the image converted to have the second resolution, and decoding the encoded image.

In the image encoding method and the image encoding apparatus according to the present disclosure, the residual data may be acquired after converting at least one of the first attention region or the second attention region according to a reference resolution.

In the image encoding method and the image encoding apparatus according to the present disclosure, the reference resolution may be selected from a plurality of resolution candidates.

In the image encoding method and the image encoding apparatus according to the present disclosure, the reference resolution may be set to be the same as the first resolution or the second resolution.

In the image encoding method and the image encoding apparatus according to the present disclosure, resolution conversion may be performed for at least one of a spatial resolution or an image quality resolution.

In the image encoding method and the image encoding apparatus according to the present disclosure, when a plurality of attention regions is detected in the original image, the reference resolution may be independently set for each of the plurality of attention regions.

In the image encoding method and the image encoding apparatus according to the present disclosure, scaling information indicating the reference resolution may be encoded in a bitstream.

In accordance with a further aspect of the present invention, there is provided an image decoding method including decoding an encoded image, determining at least one attention region in the decoded image, decoding residual data for a first attention region in the decoded image, and correcting the first attention region based on the residual data.

In accordance with a further aspect of the present invention, there is provided an image decoding apparatus including an image decoder configured to decode an encoded image, an attention region determinator configured to determine at least one attention region in the decoded image, a residual data decoder configured to decode residual data for a first attention region in the decoded image, and an image corrector configured to correct the first attention region based on the residual data.

In the image decoding method and the image decoding apparatus according to the present disclosure, the correcting may include scaling the first attention region according to a reference resolution, and adding the residual data to the scaled first attention region.

In the image decoding method and the image decoding apparatus according to the present disclosure, the reference resolution may be determined based on scaling information, and the scaling information may be index information specifying a resolution candidate corresponding to the reference resolution among a plurality of resolution candidates.

In the image decoding method and the image decoding apparatus according to the present disclosure, the scaling may be performed for at least one of a spatial resolution or an image quality resolution.

In the image decoding method and the image decoding apparatus according to the present disclosure, when a plurality of attention regions is present in the decoded image, the scaling information may be signaled for each of the plurality of attention regions.

### BRIEF DESCRIPTION OF THE DRAWINGS

The above and other objects, features and other advantages of the present invention will be more clearly understood from the following detailed description taken in conjunction with the accompanying drawings, in which:

FIG. 1 illustrates an image encoding apparatus according to an embodiment of the present disclosure;

FIG. 2 illustrates an image decoding apparatus according to an embodiment of the present disclosure;

FIG. 3 illustrates an image encoding method in the image encoding apparatus according to an embodiment of the present disclosure;

FIG. 4 illustrates an image decoding method in the image decoding apparatus according to an embodiment of the present disclosure;

FIG. 5 illustrates an example in which a combined image is generated;

FIG. 6 illustrates an example in which a packed image is generated; and

FIG. 7 illustrates an example in which a restored image is acquired.

### DETAILED DESCRIPTION OF THE INVENTION

Since the present disclosure may be variously changed and have various embodiments, specific embodiments will be illustrated in the drawings and described in detail in the detailed description. However, this is not intended to limit the present disclosure to specific embodiments, and should be understood to include all changes, equivalents, and substitutes included in the spirit and technical scope of the present disclosure. While describing each drawing, similar reference numerals are used for similar components.

Even though terms such as “first,” “second,” etc. may be used to describe various components, the components should not be limited by the terms. The terms are used only for the purpose of distinguishing one component from another. For example, a first component may be referred to as a second component, and similarly, the second component may be referred to as the first component without departing from the scope of the present disclosure. The term “and/or” includes a combination of a plurality of related stated items or any of a plurality of related stated items.

When a component is referred to as being “coupled” or “connected” to another component, the component may be directly coupled or connected to the other component. However, it should be understood that another component may be present therebetween. In contrast, when a component is referred to as being “directly coupled” or “directly connected” to another component, it should be understood that there are no other components therebetween.

The terms used in this application are only used to describe specific embodiments and are not intended to limit the disclosure. A singular expression includes a plural form unless the context clearly dictates otherwise. In this application, it should be understood that a term such as “include” or “have” is intended to designate that the features, numbers, steps, operations, components, parts, or combinations thereof described in the specification are present, and does not preclude the possibility of addition or presence of one or more other features, numbers, steps, operations, components, parts, or combinations thereof.

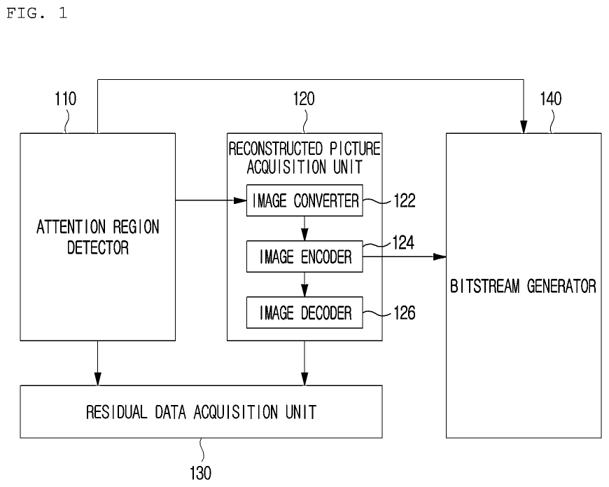

FIG. 1 illustrates an image encoding apparatus according to an embodiment of the present disclosure.

Referring to FIG. 1, the image encoding apparatus may include an attention region detector 110, a reconstructed picture acquisition unit 120, a residual data acquisition unit 130, and a bitstream generator 140.

The attention region detector 110 detects an attention region from an original image.

The attention region according to the present disclosure may mean a region of interest for a machine learning-based task. Accordingly, the attention region may be referred to as a region of interest.

The attention region detector 110 may extract one or more attention regions from the original image. A plurality of attention regions in one original image may have different sizes/shapes.

The attention region detector may re-determine a detected attention region as a non-attention region based on a size or ratio of the detected attention region. For example, when the size of the detected attention region is smaller than or equal to a threshold size preset in the image encoding apparatus, the attention region detector may reset the corresponding attention region to a non-attention region. Conversely, when the size of the detected attention region is greater than or equal to the threshold size preset in the image encoding apparatus, the attention region detector may reset the corresponding attention region to a non-attention region.

The reconstructed picture acquisition unit 120 acquires a reconstructed picture from an original image. The reconstructed picture acquisition unit 120 may include an image converter 122, an image encoder 124, and an image decoder 126.

The image converter 122 converts the original image into an image having a different resolution. As an example, the image converter 122 may convert an original image of a first resolution and generate a converted image having a second resolution.

The image encoder 124 performs encoding on a converted image.

The image decoder 126 performs decoding on an encoded image. A reconstructed picture of an original image may be acquired by image decoding.

Meanwhile, codec technology such as AV1, HEVC, or VVC may be used for image encoding/decoding.

The residual data acquisition unit 130 acquires residual data by differentiating a reconstructed attention region from an attention region of an original image. Meanwhile, to acquire residual data, a process of adjusting a resolution of the attention region of the original image and a resolution of the reconstructed attention region to be the same may be involved.

The bitstream generator 140 generates a bitstream including an image encoded by the image encoder 124 and differential data between the attention region of the original image and the reconstructed attention region. Meanwhile, the bitstream may further include information about the attention region.

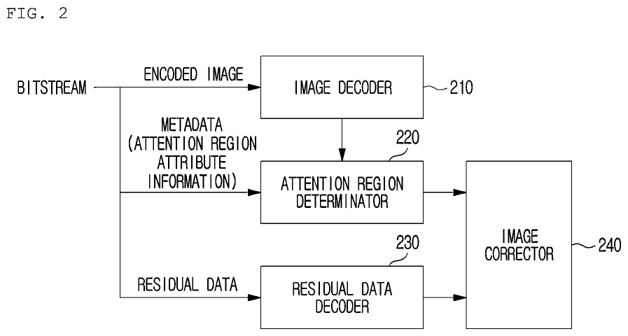

FIG. 2 illustrates an image decoding apparatus according to an embodiment of the present disclosure.

Referring to FIG. 2, the image decoding apparatus includes an image decoder 210, an attention region determinator 220, a residual data decoder 230, and an image corrector 240.

The image decoder 210 decodes an encoded image included in a bitstream. The image obtained as a result of image decoding may be referred to as a decoded image or a reconstructed picture.

The attention region determinator 220 determines an attention region in a decoded image. Meanwhile, information for determination of the attention region may be encoded and signaled as metadata. The attention region determinator 220 may determine the attention region in the decoded image based on the metadata included in the bitstream.

The residual data decoder 230 decodes residual data for the attention region included in the bitstream.

The image corrector 240 corrects the attention region of the decoded image based on the decoded residual data. Meanwhile, for correction of the decoded image, a resolution of the attention region of the decoded image may be converted in accordance with the residual data.

Hereinafter, an operation of each of the image encoding apparatus and the image decoding apparatus will be described in detail with reference to the drawings.

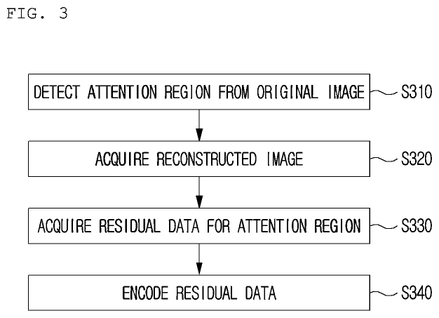

FIG. 3 illustrates an image encoding method in the image encoding apparatus according to an embodiment of the present disclosure.

Referring to FIG. 3, an attention region may be detected from an input original image (S310).

The attention region may be detected based on at least one of object detection or image segmentation. Here, object detection or image segmentation may be performed using a network for machine learning-based tasks.

Alternatively, the attention region may be detected based on an object probability map (Objectness Map) for an original image. The object probability map may represent a probability that an object exists in the original image. For example, in the object probability map, a region in which a probability value is greater than or equal to a preset threshold may be set as an attention region, and a remaining region, that is, a region in which a probability value is smaller than the preset threshold may be set as a non-attention region.

The object probability map may be a result extracted from an intermediate stage of a network (regional proposal network) for machine learning-based tasks.

For ease of encoding/decoding, the attention region may be set to a rectangular shape. Further, a boundary of the attention region may be set to match a boundary of an encoding/decoding unit in the image. Here, the encoding/decoding unit may include at least one of a slice, a tile, a coding tree unit, a coding unit, or a transform unit.

Referring to FIG. 3, a reconstructed picture of the original image may be acquired (S320).

Here, the reconstructed picture may be generated by encoding and decoding the original image. That is, the reconstructed picture may be an image acquired by decoding an encoded image (that is, a decoded image).

Meanwhile, in acquiring the reconstructed picture, the original image may be converted into an image with a predetermined resolution. Then, encoding and decoding may be performed on the converted image to acquire a reconstructed picture.

Here, the resolution may include at least one of a spatial resolution or an image quality resolution. The spatial resolution may be converted by resizing an image size, and the image quality resolution may be converted by quantization information (for example, at least one of a quantization parameter or a quantization step size).

For example, an original image having a first resolution may be converted into an image having a second resolution. By performing encoding and decoding on the image converted to have the second resolution, a reconstructed picture may be acquired.

In this case, the original image may have the first resolution, while the reconstructed picture may have the second resolution. Meanwhile, the resolution of the reconstructed picture (that is, the second resolution) may be a spatial or/and image quality resolution smaller than the resolution of the original image (that is, the first resolution).

Resolution conversion for the original image may be performed according to a rule predefined in the image encoding apparatus. As an example, the original image of the first resolution may be converted to have the second resolution pre-promised in the image encoding apparatus.

Alternatively, resolution conversion on the original image may be performed based on at least one of N spatial resolution candidates or M image quality resolution candidates, which will be described later.

In the image encoding apparatus, the second resolution may be determined based on at least one of the resolution of the original image, the number of attention regions, or a ratio occupied by the attention region in the original image.

Referring to FIG. 3, residual data may be calculated based on the attention region of the original image and the attention region of the reconstructed picture (S330). Here, the attention region of the reconstructed picture may refer to a region corresponding to the attention region of the original image.

Meanwhile, when the resolution is different between the original image and the reconstructed picture, scaling may be performed to equalize the resolution between the attention region of the original image and the attention region of the reconstructed picture. In other words, scaling may be understood as a process of adjusting at least one of the spatial resolution or the image quality resolution in a partial region in the image.

For example, scaling may be performed to match the resolution of the reconstructed picture (that is, the second resolution) with the attention region of the original image having the first resolution (hereinafter referred to as an original attention region), thereby acquiring an original attention region having the second resolution.

Alternatively, scaling may be performed to match the resolution of the original image (that is, the first resolution) with the attention region of the reconstructed picture having the second resolution (hereinafter referred to as a reconstructed attention region), thereby acquiring a reconstructed attention region having the first resolution.

Alternatively, each of the original attention region having the first resolution and the reconstructed attention region having the second resolution may be adjusted to have any third resolution. That is, scaling may be performed on the original attention region having the first resolution to acquire a scaled original attention region having the third resolution, and scaling may be performed on the reconstructed attention region having the second resolution to acquire a scaled reconstructed attention region having the third resolution.

The scaling may be understood as a process of adjusting/maintaining at least one of a spatial resolution or an image quality resolution of a partial region in an image. Through scaling, the original attention region and the reconstructed attention region may be adjusted to have the same resolution. A resolution serving as a target in scaling may be referred to as a reference resolution. For example, when the original attention region having the first resolution and the reconstructed attention region having the second resolution are scaled to have the third resolution, the third resolution may be the reference resolution.

In the image encoding apparatus, each of N spatial resolution candidates (R₁, R₂, . . . , R_{N-1}, R_{N}) and M image resolution candidates (Q₁, Q₂, . . . , Q_{M-1}, Q_{M}) may be defined. Here, each of N and M is 1 or a natural number greater than 1, and may be the same value or different values.

For example, the spatial resolution candidates may range from 25 to 100, and a difference from the spatial resolution candidates may be 25. The image quality resolution candidates may range from 22 to 47, and a difference from the image quality resolution candidates may be 5. In other words, four spatial resolution candidates, that is, (25, 50, 75, 100), and six image quality resolution candidates, that is, (47, 42, 37, 32, 27, 22), may be defined in the image encoding apparatus.

The scaling may be performed only for one of the spatial resolution or the image quality resolution. As an example, the scaling may be performed based on one of N spatial resolution candidates or one of M image quality resolution candidates. That is, the reference resolution may correspond to any one of the N spatial resolution candidates or any one of the M image quality resolution candidates.

Alternatively, the scaling may be performed for both the spatial resolution and the image quality resolution. As an example, the scaling may be performed based on a combination of one of the N spatial resolution candidates and one of the M image quality resolution candidates. That is, the reference resolution may correspond to a combination of any one of the N spatial resolution candidates and any one of the M image quality resolution candidates.

When a plurality of attention regions is present in an image, reference resolutions for the plurality of attention regions may be the same.

Alternatively, the reference resolution may be independently determined for each of the plurality of attention regions.

In the image encoding apparatus, the reference resolution may be adaptively determined based on the resolution of the original image (that is, the first resolution) and the resolution of the reconstructed picture (that is, the second resolution). As an example, the image encoding apparatus may set the reference resolution to be the same as the first resolution or the second resolution.

Alternatively, the image encoding apparatus may adaptively determine the reference resolution based on at least one of a ratio between the first resolution and the second resolution, a size of the attention region, or an attribute of the attention region.

Residual data for the attention region may be acquired through a difference operation between the original attention region and the reconstructed attention region having the same resolution. Since the original attention region and the reconstructed attention region are adjusted to the reference resolution, the residual data may have the reference resolution.

Referring to FIG. 3, the acquired residual data may be encoded (S340). The residual data may be encoded in the form of a residual image representing a difference value for each pixel in the image.

The bitstream may include residual data representing a difference between the original attention region and the reconstructed attention region and an encoded image for the original image. In this instance, the encoded image may be acquired by encoding an image having the second resolution converted from the original image having the first resolution.

That is, while the encoded image is an image including both the attention region and the non-attention region (for example, background region), residual data may be additionally encoded only for the attention region. Meanwhile, the bitstream may further include metadata. The metadata may include at least one of resolution information on the original image, resolution information on the encoded image, scaling information, or information on the attribute of the attention region.

The resolution information on the original image may include at least one of spatial resolution information or image quality resolution information for the original image. As an example, the spatial resolution information may include at least one of size information of the original image or index information indicating one of a plurality of spatial resolution candidates. The image quality resolution information may include at least one of quantization information of the original image or index information indicating one of a plurality of image quality resolution candidates.

The resolution information on the encoded image may include at least one of spatial resolution information or image quality resolution information for the encoded image. As an example, the spatial resolution information may include at least one of size information of the encoded image, scaling parameter information according to a spatial resolution ratio between the encoded image and the original image, or index information indicating one of a plurality of spatial resolution candidates. The image quality resolution information may include at least one of quantization information of the encoded image, scaling parameter information according to an image quality resolution ratio between the encoded image and the original image, or index information indicating one of a plurality of image quality resolution candidates.

The scaling information includes scaling information for at least one of the original attention region or the reconstructed attention region. That is, the scaling information may indicate the reference resolution. The scaling information may include at least one of a value of a scaling parameter or index information indicating one of resolution candidates.

The scaling information may be encoded for at least one of the spatial resolution or the image quality resolution. As an example, the scaling information may include at least one of index information indicating one of spatial resolution candidates or index information indicating one of image quality resolution candidates.

Meanwhile, one of the plurality of attention regions may have different resolution or scaling information from that of another one. Accordingly, the scaling information may be independently encoded for each of a plurality of attention regions belonging to one original image.

The information on the attribute of the attention region may include at least one of size information of the attention region, pixel value information for the attention region, information on a type of object belonging to the attention region, information on adjacency between attention regions, number information of the attention region, location information of the attention region, or object detection rate information.

Here, the size information of the attention region may be related to at least one of a width, a height, a product of the width and the height, or a ratio of the width to the height of the attention region.

The pixel value information for the attention region may be related to a minimum value and a maximum value among pixel values belonging to the attention region or a difference between the minimum value and the maximum value, or may be related to the amount of change in pixel value in the attention region.

The information on the type of object belonging to the attention region may be related to whether the object belonging to the attention region is a dynamic object or whether the object belonging to the attention region is related to a person.

The information on adjacency between attention regions may include information identifying another attention region adjacent to a current attention region. The number information of the attention region indicates the number of attention regions included in the image. Here, the image represents the original image or the encoded image.

The location information of the attention region indicates a location of the attention region in the image. The location of the attention region may be determined based on a specific location in the image. For example, assuming that an upper left position of the image is (0, 0), the location of the attention region may be calculated.

Alternatively, location information of the current attention region may be encoded based on a location of an adjacent attention region. For example, when the location of the adjacent attention region is (x1, y1) and the location of the current attention region is (x2, y2), location information for the current attention region may be encoded as (x2−x1, y2−y1).

A plurality of attention regions may be detected from one original image, and in this case, it is obvious that residual data may be calculated and encoded for each of the plurality of attention regions. In this case, information identifying an attention region for the residual data may be additionally encoded.

In addition, one of the plurality of attention regions may have different resolution or scaling information from that of another one. That is, the scaling information may be independently determined for each of a plurality of attention regions belonging to one original image.

To increase restoration accuracy for the attention region, a combined image having different resolutions for the attention region and the non-attention region may be encoded to acquire an encoded image.

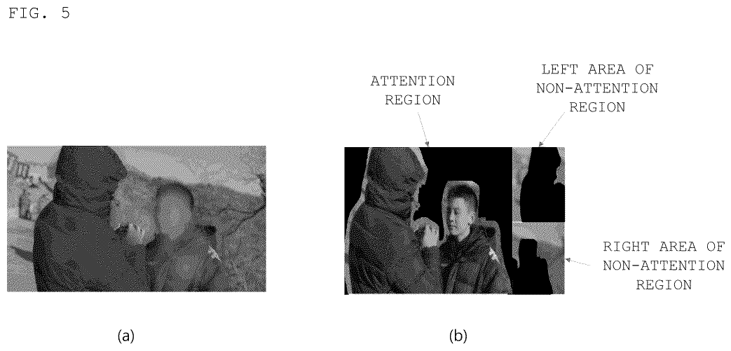

FIG. 5 illustrates an example in which a combined image is generated.

FIG. 5A illustrates an attention region in an original image.

After separating the attention region and a non-attention region in the original image, the separated regions may be rearranged to create a combined image.

For example, in an example illustrated in FIG. 5B, the attention region, a left area of the non-attention region, and a right area of the non-attention region are packed and a combined image is acquired.

In this instance, to reduce the amount of encoded data, conversion may be performed to lower the resolution on at least one of the separated regions. To increase restoration accuracy for the attention region, the conversion may be performed only for the non-attention region.

Alternatively, conversion may be performed to lower the resolution for both the attention region and the non-attention region, and the resolution of the converted non-attention region may be set to have a smaller value than that of the resolution of the converted attention region.

Meanwhile, when the encoded image and the residual image including the residual data are encoded/decoded, respectively, there is a problem that the number of encoders/decoders required increases. To solve the above problem, an image obtained by packing the converted image and the residual image including the residual data may be generated, and the packed image may be encoded. Here, the converted image may be created by converting the original image to have a lower resolution than that of the original image.

As above, by encoding/decoding the packed image instead of encoding/decoding each of the encoded image and the residual data, the number of encoders/decoders required may be reduced.

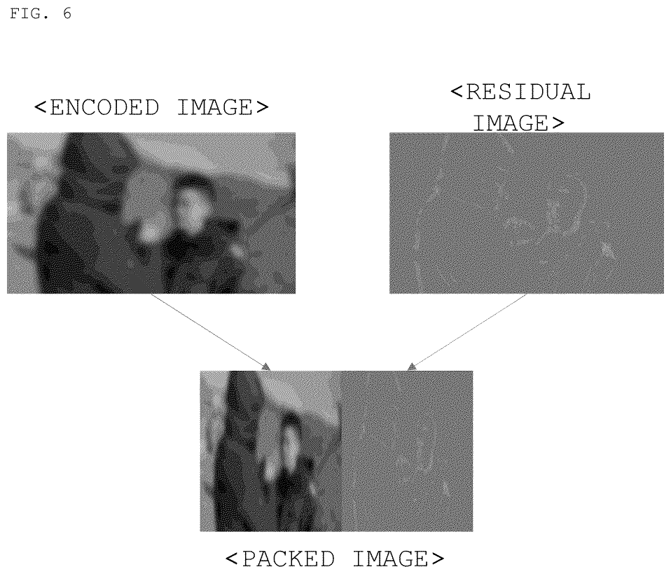

FIG. 6 illustrates an example in which a packed image is generated.

As in the example illustrated in FIG. 6, a packed image may be generated by packing the converted image and the residual image including the residual data for the attention region into one image.

In this instance, to reduce the encoded data, the resolution of the converted image may have a smaller value than that of the resolution of the original image.

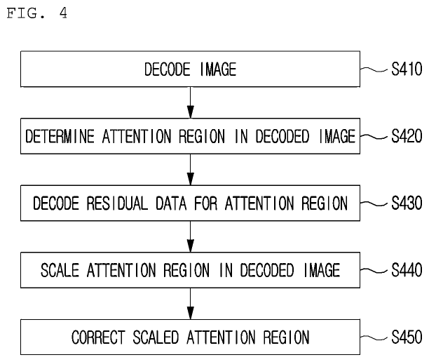

FIG. 4 illustrates an image decoding method in the image decoding apparatus according to an embodiment of the present disclosure.

The image decoding method may be understood as a reverse process of the image encoding method discussed earlier. Therefore, since the description of the image encoding method may be equally/similarly applied to the image decoding method, a redundant description will be omitted here.

Referring to FIG. 4, an encoded image included in a bitstream may be decoded to acquire a decoded image (S410).

Here, the encoded image may have a different resolution from that of an original image. For example, the original image may have a first resolution, while the encoded image may have a second resolution smaller than the first resolution. Accordingly, the decoded image may have the second resolution smaller than the first resolution.

Referring to FIG. 4, an attention region may be determined for the decoded image (S420).

The attention region in the decoded image may be determined based on metadata parsed from the bitstream. Specifically, the attention region in the decoded image may be determined based on information on an attribute of the attention region decoded from the bitstream.

Referring to FIG. 4, the bitstream may be decoded to acquire residual data corresponding to the attention region (S430). When a plurality of attention regions is present, residual data may be encoded and signaled for each attention region. In this case, correction, which will be described later, may be performed based on the residual data corresponding to the attention region. Alternatively, a single residual image including residual data for a plurality of attention regions may be encoded and signaled.

Further, scaling may be performed on the attention region based on scaling information for the attention region (or residual data corresponding to a detected attention region) (S440).

The scaling information may indicate a reference resolution for the attention region. Through scaling, the resolution of the attention region in the decoded image may be adjusted/maintained to be the same as that of the residual data acquired from the bitstream. In other words, through scaling, the attention region in the decoded image may be adjusted according to the reference resolution.

A plurality of attention regions may be detected from the decoded image, and scaling information may be signaled for each of the plurality of attention regions. In this case, scaling may be sequentially or serially performed on the plurality of attention regions based on a predetermined priority. Alternatively, scaling may be performed in parallel for the plurality of attention regions based on signaled scaling information.

Meanwhile, when the resolution of the decoded image and the reference resolution are the same, a step of performing scaling on the attention region (S440) may be omitted.

Referring to FIG. 4, a pixel value of the scaled attention region may be corrected based on the acquired residual data (S450). Specifically, the pixel value of the scaled attention region may be corrected by adding residual data to the scaled attention region.

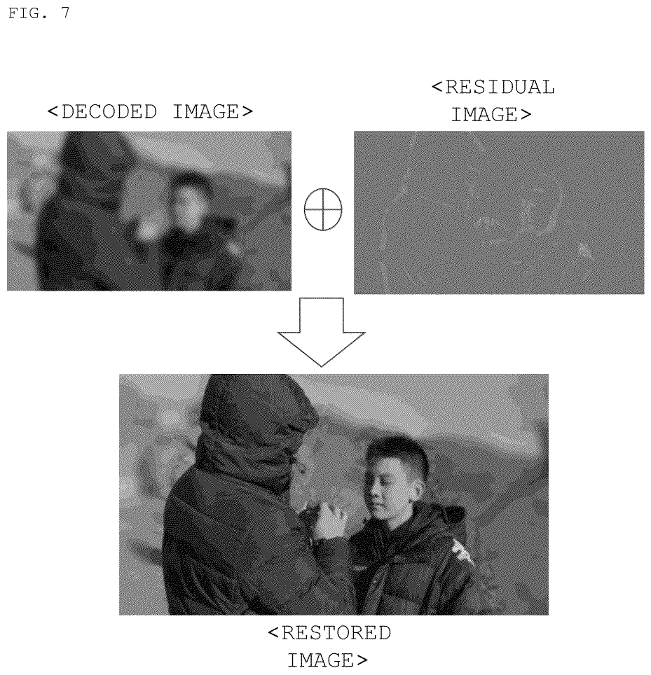

Meanwhile, when the decoded image is a combined image in which the attention region and the non-attention region are rearranged, it is possible to perform a process of readjusting the attention region and the non-attention region in the decoded image to original arrangement. FIG. 7 illustrates an example in which a restored image is acquired.

The non-attention region is restored using only the decoded image.

On the other hand, the attention region may be restored by adding residual data to the decoded image.

Accordingly, as in the example illustrated in FIG. 7, the non-attention region may be restored with low quality, while the attention region may be restored with relatively high quality.

Meanwhile, the decoded image including the corrected attention region may be converted to have the same resolution as that of the original image. The image converted to have the same resolution as that of the original image may be used for machine learning-based tasks or human vision.

Unlike the description given through steps S440 to S450, after adjusting the decoded image and the residual data to the resolution of the original image, a pixel value of the attention region in the converted decoded image may be corrected according to the resolution of the original image.

As in the above example, by correcting the attention region, a restoration error for the attention region may be significantly reduced.

Meanwhile, the image may be encoded to support spatial scalability.

That is, a plurality of images having different resolutions may be generated from the original image, and a unique layer identifier may be assigned to each of the plurality of images. In this instance, an image having a lowest layer identifier value may be defined as a base layer image, and the other images may be defined as enhancement layer images.

Meanwhile, when spatial scalability is supported, residual data for an attention region between neighboring layers may be generated.

For example, residual data may be obtained between a first layer image having a first resolution and a second layer image having a second resolution. Assuming that the first resolution is smaller than the second resolution, the first layer image may be upscaled according to the second resolution, and then the upscaled first layer image and the second layer image may be differentiated to acquire residual data for an attention region.

When a specific layer image is restored, residual data for lower layers may be used in series.

For example, when the second layer image is desired to be restored, the first layer image may be decoded and then the decoded first layer image may be upscaled according to the second resolution. Thereafter, the second layer image may be restored by adding residual data between the first layer image and the second layer image to the upscaled first layer image.

Similarly, when a third layer image having a third resolution is desired to be restored, the reconstructed second layer image may be upscaled according to the third resolution according to the above description. Thereafter, the third layer image may be restored by adding residual data between the second layer image and the third layer image to the upscaled second layer image.

Applying the embodiments described focusing on a decoding process or encoding process to the encoding process or decoding process falls within the scope of the present disclosure. Modifying the embodiments described in the given order in an order different from that described falls within the scope of the present disclosure.

Even though the above-mentioned disclosure is described based on a series of steps or a flowchart, this does not limit the chronological order of the invention, and may be performed simultaneously or in a different order as needed. In addition, each of the components (for example, units, modules, etc.) included in the block diagrams in the above-described disclosure may be implemented as a hardware device or software, and a plurality of components may be combined to form a single hardware device or software. The above-described disclosure may be implemented as program instructions executable through various computer components and recorded on a computer-readable recording medium. The computer-readable recording medium may include program instructions, data files, data structures, etc., singly or in combination. Examples of the computer-readable recording medium include a specially configured hardware device to store and execute program instructions such as a magnetic medium such as a hard disk, a floppy disk, and a magnetic tape, an optical recording medium such as a CD-ROM or a DVD, a magneto-optical medium such as a floptical disk, a ROM, a RAM, or a flash memory. The hardware device may be configured to operate as one or more software modules to perform processing according to the present disclosure, and vice versa. The apparatus according to the present disclosure may have program instructions for storing or transmitting a bitstream generated by the above-described encoding method.

According to the present disclosure, even when encoding/decoding an image having a smaller resolution than that of an original image, there is an effect of minimizing restoration errors in an attention region by using residual data.

According to the present disclosure, by suppressing occurrence of image quality degradation in an attention region, performance may be maintained or improved as much as possible when applied to a machine learning-based task.

What is claimed is:

1. An image encoding method comprising:
detecting at least one attention region from an original image;
acquiring a reconstructed picture for the original image;
generating residual data between a first attention region in the original image and a second attention region corresponding to the first attention region in the reconstructed picture; and
encoding the residual data.

2. The image encoding method according to claim 1, wherein the acquiring comprises:
converting the original image having a first resolution to have a second resolution;
encoding the image converted to have the second resolution; and
decoding the encoded image.

3. The image encoding method according to claim 2, wherein the residual data is acquired after converting at least one of the first attention region or the second attention region according to a reference resolution.

4. The image encoding method according to claim 3, wherein the reference resolution is selected from a plurality of resolution candidates.

5. The image encoding method according to claim 3, wherein the reference resolution is set to be the same as the first resolution or the second resolution.

6. The image encoding method according to claim 3, wherein resolution conversion is performed for at least one of a spatial resolution or an image quality resolution.

7. The image encoding method according to claim 3, wherein, when a plurality of attention regions is detected in the original image, the reference resolution is independently set for each of the plurality of attention regions.

8. The image encoding method according to claim 3, wherein scaling information indicating the reference resolution is encoded in a bitstream.

9. An image decoding method comprising:
decoding an encoded image;
determining at least one attention region in the decoded image;
decoding residual data for a first attention region in the decoded image; and
correcting the first attention region based on the residual data.

10. The image decoding method according to claim 9, wherein the correcting comprises:
scaling the first attention region according to a reference resolution; and
adding the residual data to the scaled first attention region.

11. The image decoding method according to claim 10, wherein:
the reference resolution is determined based on scaling information; and
the scaling information is index information specifying a resolution candidate corresponding to the reference resolution among a plurality of resolution candidates.

12. The image decoding method according to claim 10, wherein the scaling is performed for at least one of a spatial resolution or an image quality resolution.

13. The image decoding method according to claim 11, when a plurality of attention regions is present in the decoded image, the scaling information is signaled for each of the plurality of attention regions.

14. An image encoding apparatus comprising:
an attention region detector configured to detect at least one attention region from an original image;
a reconstructed picture acquisition unit configured to acquire a reconstructed picture for the original image;
a residual data acquisition unit configured to generate residual data between a first attention region in the original image and a second attention region corresponding to the first attention region in the reconstructed picture; and
a bitstream generator configured to generate a bitstream including the residual data.

15. An image decoding apparatus comprising:
an image decoder configured to decode an encoded image;
an attention region determinator configured to determine at least one attention region in the decoded image;
a residual data decoder configured to decode residual data for a first attention region in the decoded image; and
an image corrector configured to correct the first attention region based on the residual data.
